(19) United States
(12) Patent Application Publication
(10) Pub. No.: US 2005/0021493 A1
(43) Pub. Date: Jan. 27, 2005

(54) Recording medium and file management system

(75) Inventors: Taku Hoshizawa, Kawasaki (JP); Naozumi Sugimura, Yokohama (JP); Harukazu Miyamoto, Hidashimurayama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/699,384

(22) Filed: Oct. 31, 2003

(30) Foreign Application Priority Data
Jul. 7, 2003 (JP) 2003-192560

(51) Int. Cl. G06F 17/30

(52) U.S. Cl. 707/1

(57) ABSTRACT

A file system is capable of managing more files without losing compatibility with conventional file systems, specifically, a file system where one disc can freely be used for an AV apparatus and for a PC. According to this invention, combined use of PCFS (file system for PC) and the main AVFS (file system for AV) is employed or simultaneous use of AVFS and PCFS is employed. According to the invention, it is possible to provide a new file system capable of managing more files and to provide an environment in which one disc can be used in a plurality of environments while compatibility with the conventional one file system is maintained by employing combined two file systems or by employing two file systems together.

### BACKGROUND OF THE INVENTION

1. Field of the Invention

This invention relates to management of a file recorded on a recording medium, and specifically relates to management of a file when file-type data is recorded on and regenerated from a recording medium designed for random access devices. For example, the invention may be applied to optical discs, magnetic discs, and semiconductor memories.

2. Description of the Related Art

On a recording medium used for an optical disc apparatus and magnetic disc apparatus, data are recorded as file-type data for easy access to the recorded data file. To manage the data, a file management method (file system) is employed. The file information recorded on a recording medium is stored as data. This file information is called file management information.

CD-ROM has been popularly used, especially optical discs. CD-ROM generally employs a file system called ISO-9660. According to ISO-9660, a table called a pass table, is used to describe the directory structure. Numbers are successively given to each pass table to which a value of 16 bits is assigned.

DVD has also been popular as a higher density optical disc. DVD typically employs a UDF (Universal Disc Format) file system. According to UDF, the file identifier and table called a file table that are given to each directory are used to describe the directory structure.

Further, a file system for recording/regenerating AV data is disclosed in JP-A (Japanese Published Unexamined Patent Application) No. 312378/1999 (Heisei 11). This file system is uses a data management table such as a file table as file management information, and to assign a value of 16 bits to manage the registered table.

### BRIEF SUMMARY OF THE INVENTION

One conventional file system, 16 bits are used to indicate the table number used for file management, and thus a table number will have a value in a range from 0 to 65535. Therefore, the maximum number of tables is limited to 65536, that is, the number of files and directories to be managed in this file system is limited to 65536.

In contrast, the memory capacity of recording media such as optical discs and magnetic discs has been increasing, allowing the number of recordable files to be increase. Under the circumstances, various file systems with conventional methods, which have been used widely as the file systems, have not been suitable for handling large capacity discs. A UDF file system, for example, for a PC, can manage many files because it is designed for an unlimited number of tables. However, this file system is not necessarily supported on all apparatuses.

The modification of the file system accompanies loss of compatibility with other conventional apparatuses. Thus substantial modification of the file system should particularly be avoided. In addition, AV (Audio Visual) apparatuses including the videodisc recorders are designed to resist such modification of software in general, and to exclusively regenerate only discs compatible with the conventional file system. Furthermore, the file system for PCs needs to manage many small-size files. In the file system of a recording medium such as an optical disc, a rewritable unit is relatively large, wasting otherwise usable recording areas when small files are recorded.

This invention provides a file system compatible with conventional file systems, but is capable of managing more files. Specifically, the invention provides a system environment where one disc can freely be used for an AV apparatus and for a PC without need for allowances for differences in file systems.

In a first aspect of the invention, a recording medium on which a file for storing the write data and the file management information for managing the file are recorded. The first file management information for managing a first file and the second file management information for managing a second file are recorded as file management information. The number of files the second file management information can manage is larger than the number of files the first file management information can manage, and the first file management information includes the management information for managing the recording area of the first and second files.

In a second aspect of the invention, a recording medium on which a file for storing the write data and the file management information for managing the file are recorded. The first file management information for managing a first file and the second file management information for managing a second file that is different from the first file management information are recorded as the file management information, the number of files the second file management information can manage is larger than the number of files the first file management information can manage, and the second file management information includes the management information for managing the recording area of the first and second files.

In a third aspect of the invention, a recording medium has a directory relating to the first file recording area and a directory relating to the second file recording area, wherein the first file management information as described in the first aspect is included in the directory structure.

In a fourth aspect of the invention, a recording medium has the directory relating to the first file recording area and the directory relating to the second file recording area, wherein the second file management information as described in the second aspect is included in the directory structure.

In a fifth aspect of the invention, regenerating apparatus for regenerating the recording medium as described in the third aspect, wherein the directory that relates to the first file recording area is displayed and the directory that relates to the second file recording area is not displayed, when the directory of the first file management information is displayed on a monitor.

In a sixth aspect of the invention, a regenerating apparatus for regenerating the recording medium as described in the fourth aspect, wherein the directory that relates to the second file recording area is displayed and the directory that relates to the first file recording area is not displayed when the directory of the second file management information is displayed on a monitor.

### BRIEF DESCRIPTION OF THE DRAWINGS

Preferred embodiments of the present invention will be described in detail in conjunction with the drawings, wherein:

FIG. 1 is a diagram for comparing file systems;

FIG. 2 is an allocation diagram of AVFS on a recording medium;

FIG. 3 is an allocation diagram of PCFS (UDF) on a recording medium;

FIG. 4 is an allocation diagram of AVFS having expanded AVFS as a sub-file system on a recording medium;

FIG. 5 is an allocation diagram having two file systems, namely AVFS and PCFS, together on a recording medium;

FIG. 6 is an allocation diagram of AVFS having PCFS as a sub-file system on a recording medium;

FIG. 7 is an allocation diagram of PCFS having AVFS as a sub-file system on a recording medium;

FIG. 8 is a diagram showing a directory structure of AVFS;

FIG. 9 is a diagram showing a directory structure of expanded AVFS in AVFS or PCFS;

FIG. 10 is a diagram showing a virtual directory structure in a new file system; and

FIG. 11 is an allocation diagram on a recording medium that shows management of AVFS management area divided into block units.

### DETAILED DESCRIPTION OF THE INVENTION

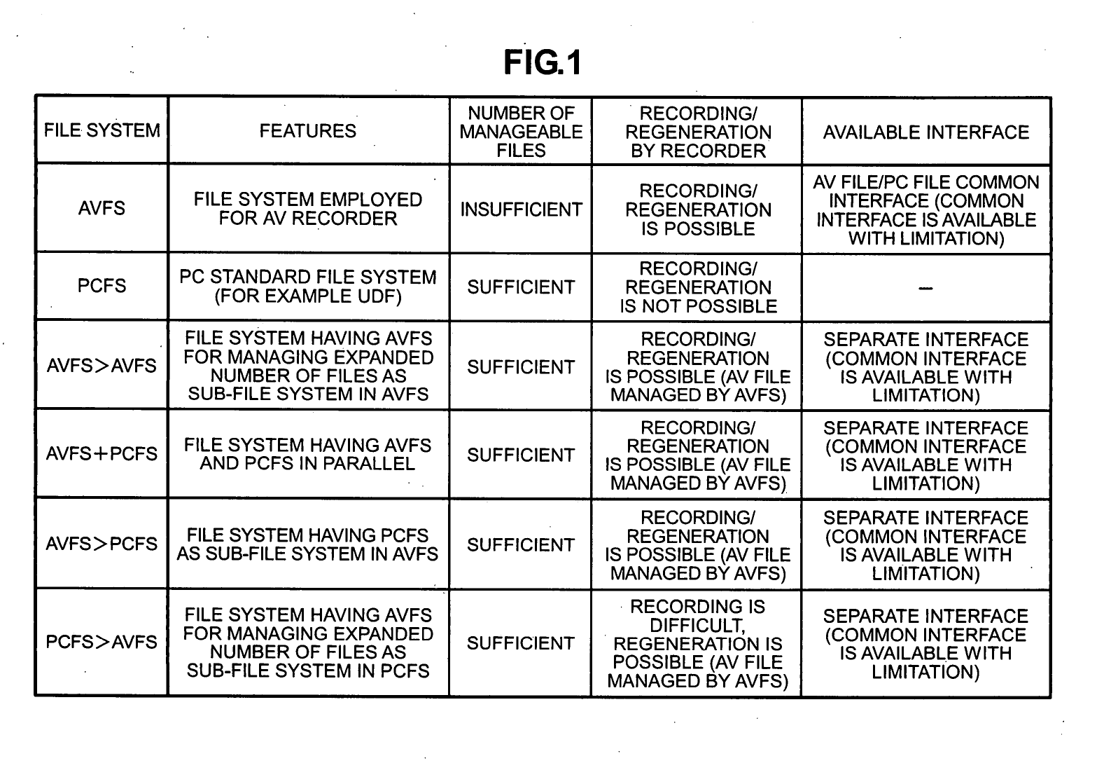

FIG. 1 is a table comparing file systems, including such characteristics of the file system as the number of manageable files, compatibility with AV recorders, and the user interface with PCs that relate to the present invention. In this table, AVFS in the top row is a file system used for an AV apparatus, particularly for an AV recorder, and a file system disclosed in JP-A No. 312378/1999 (Heisei 11) is used exemplarily herein. PCFS in the second row is a file system generally used for a recording medium for PCs, and UDF that is now widely used for DVDs is used exemplarily herein.

The file system of the invention in the third row (AVFS>AVFS) is a file system having the expanded AVFS that basically has the same file management structure as that of AVFS, namely the main file system, as the sub-file system of AVFS so that the file system manages the expanded number of files. For example, when a management number of 16 bits is used for file management in AVFS, a management number of 32 bits is used for the expanded AVFS as in the case of UDF that is typical of PCFS.

The file system of the invention in the fourth row (AVFS+PCFS) is a file system or disc using method having AVFS and PCFS in parallel in which the managing file system is switched depending on the type of a file to be recorded or regenerated. For example, AVFS is employed as the file system to manage the file and the file is recorded in the AVFS managing area of a recording medium when the file to be recorded is an AV file. Note that AV file in this description means all the files that are recorded by means of an AV recorder or a PC with AV recorder function in pursuance of the AV recorder. On the other hand, PCFS is employed as the file system to manage the file and the file recorded in the PCFS managing area of a recording medium is regenerated when that the file to be regenerated is a PC file (the PC file in this description means arbitrary files other than AV files. Therefore, the PC file includes MPEG files and JPEG files that are used generally on PCs).

The file system of the invention in the fifth row in the table of FIG. 1 (AVFS>PCFS) is a file system having PCFS as the sub-file system of AVFS. This file system is different from AVFS+PCFS in that PCFS, namely the sub-file system of AVFS, directly manages the PC file and the PC file is allocated in the PCFS managing area in the case of AVFS+PCFS. PCFS, the sub-file system of AVFS, manages the file, and the file is allocated in the PCFS managing area in the AVFS managing area in the case of AVFS>PCFS. Herein, the sub-file system means a file system for managing only the files allocated in the managing area, which is a part of the area partitioned as a managing area, although the main file system basically manages the area of the whole recording medium.

The file system of the invention in the bottom row (PCFS>AVFS) is a file system having AVFS as sub-file system of PCFS. This file system is different from AVFS>PCFS in that PCFS, that is the sub-file system of AVFS, manages the PC file and the PC file is allocated in the PCFS managing area in the AVFS managing area in the case of AVFS>PCFS; conversely, PCFS directly manages the PC file in the case of PCFS>AVFS. AVFS directly manages the AV file and the AV file is allocated in the AVFS managing area in the case of AVFS>PCFS, but in the case of PCFS>AVFS, AVFS, that is the sub-file system of PCFS, manages the AV file at least when the AV file is recorded and the AV file is allocated in the AVFS managing area in the PCFS managing area.

Next, the number of files manageable by means of these file systems is compared.

AVFS employs a 16 bit value for managing files, and the number of manageable files and directories is consequently limited to 65536 at most. For example, in the case of a recording medium having a recording capacity of 64 GB, the file size of one file is about 1 MB on average. The 1 MB is insufficient for the PC file system because the file size used substantially for PCs ranges from several tens of kilobytes to several hundreds of kilobytes.

The number of manageable files is sufficient in the case of other file systems because the PC file is managed by means of PCFS or expanded AVFS. The next column shows whether the recording medium managed by means of respective file systems can be used for recording and regeneration by use of an AV recorder.

AVFS can be employed for recording/regeneration of all the files including PC files by use of an AV recorder. However, recording/regeneration of a PC file by use of an AV recorder is not so advantageous because an AV recorder is used exclusively for AV files. A recording medium in which PCFS is employed cannot be used for recording/regeneration by use of an AV recorder. An AV recorder cannot detect the file information managed by means of PCFS. As the result, a file in a recording medium formatted by means of PCFS is erased because the AV recorder formats the recording medium to thereby change the format from PCFS to AVFS. In the case of a file system which has AVFS as one of the main file systems (AVFS, AVFS>AVFS, AVFS+PCFS, or AVFS>PCFS), all the AV files are managed by means of AVFS, and an AV recorder can be used for recording/regeneration of all the files managed by means of AVFS. In the case of PCFS>AVFS, regeneration of an AV file managed by means of AVFS that is employed as a sub-system can be realized by disposing an FSD (File System Descriptor: data for indicating the position of the file system on the recording medium) for sub-file at the position in accordance with AVFS, namely a fixed address on the recording medium assigned previously according to AVFS. However, recording of an AV file is complex or difficult in the aspect of recordable file size and address management because the recording area is managed by means of the PCFS that is the main file system. Finally, the ease or convenience of an interface on a PC, particularly a user interface with a display, is compared.

With management of all the files by means of AVFS, conceptually all the files can be managed in the same manner. However, all the AV apparatuses are substantially engaged in recording/regeneration of the AV files, and all the files are often managed according to a predetermined file rule (for example, file extension) under the directory structure based on a predetermined rule. Herein, the term “directory structure” means the relation between the directory and file; “the directory structure based on a predetermined rule” means that a file having an extension determined to be allocated under the directory having a predetermined name, is disposed with a predetermined path. From this viewpoint, it is possible to provide the environment for managing AV files and PC files with a PC without discrimination. However, in consideration of the situation that general users use PCs widely, a lot of countermeasures are needed so that the rule determined for the AV file on a recording medium is not destroyed regardless of the user's intention. As a result, it is predicted that AVFS falls in the same situation as other file systems. An exemplary interface is described later. It is necessary that a PC record/regenerate an AV file (namely, the file in the directory structure specified for an AV apparatus) by use of an application to be exclusively used for AV files and that the PC record/regenerate a PC file by use of an application for managing files on a recording medium such as Explorer supplied by an OS manufacturer.

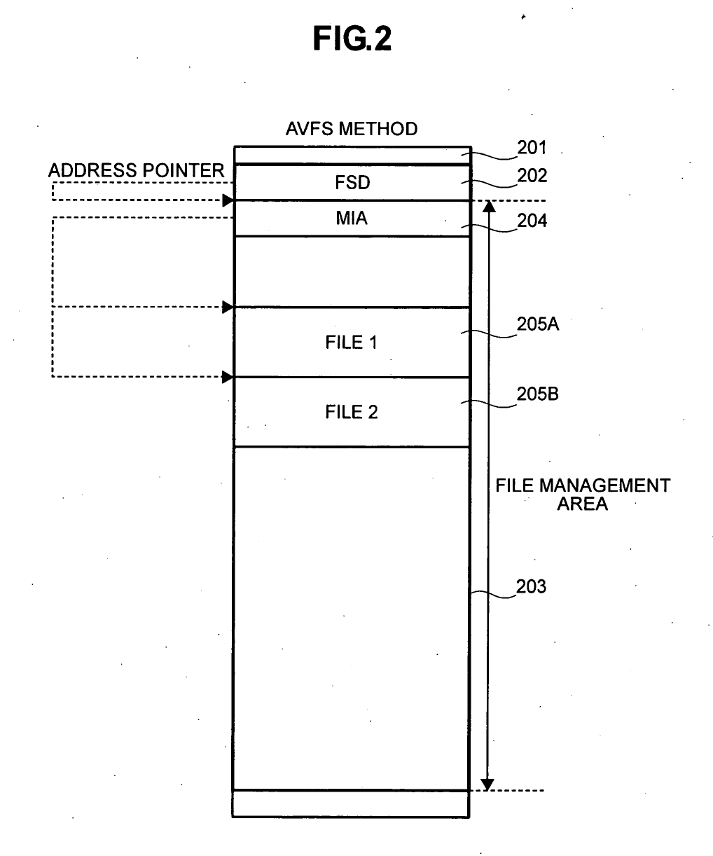

Next, how the file and file management information are disposed on a recording medium and how the file is managed are described with reference to FIGS. 2 to 6 for the respective file systems.

FIG. 2 shows the file and file allocation on a recording medium to which the AVFS file system is applied. In FIG. 2, 201 denotes a recording medium; 202 denotes FSD (File System Descriptor); 203 denotes the recording area on which files and file management information are recorded; 204 denotes MIA (Management Information Area); and 205 denotes the file

FSD 202 shows the detailed position of file management information positioned in MIA 204. The file management information is managed in table style for respective information content types and includes a management information allocation table, file table, recording area table, allocation rule set table, and file identifier table. The file management information is updated on the recording medium with circulation in MIA 204.

The allocation information of each table in the file management information is recorded on the management information allocation table that is a component of the file management information. In detail, the allocation information includes the recording start number of each table, existence or nonexistence of a continuous table from the table number, or continuous table number. The area allocation information serves as reference for the contents of each table.

The file table includes the file identifier table number that corresponds to the file, link information that shows the directory relation, file attribute, number of the expanded attribute information table, file type, file generation time, and file amendment time. The file table is referred to find the table number that corresponds to each file in each table.

The information on the recording position of each file on a disc is recorded on the recording area table. In detail, the information includes the information of the recording start sector number of the file, recording start position, recording end sector number, and recording end position. The sector number on which the file data is recorded is obtained from the recording area table and the data is read when the content of the file data is to be read.

The division allocation information of the data allocated on a disc is recorded on the allocation rule set table. The division allocation information serves to define the minimum division size when the data is recorded on a disc so that the data is read continuously. For example, when a sector is used continuously in 4096 sector (8 MB) units, 4096 is set as the parameter.

The file identifier table includes the name of a file identifier and the length of the file identifier. In the case that one file identifier table has 32 bytes and 4 bytes are allocated to the file identifier length, the data area of 28 bytes can be assigned to the file identifier itself. The above-mentioned tables are composed of 16 bytes and 32 bytes respectively. However, if the area for recording is deficient, multiple copies of the table may be used to increase the data length to be recorded.

As described above, AVFS searches the file management information in MIA 204 from FSD 202 of the fixed address at the top, and specifies the position and name of various files allocated in the file and file management information recording area 203 from various tables that are components of the file management information.

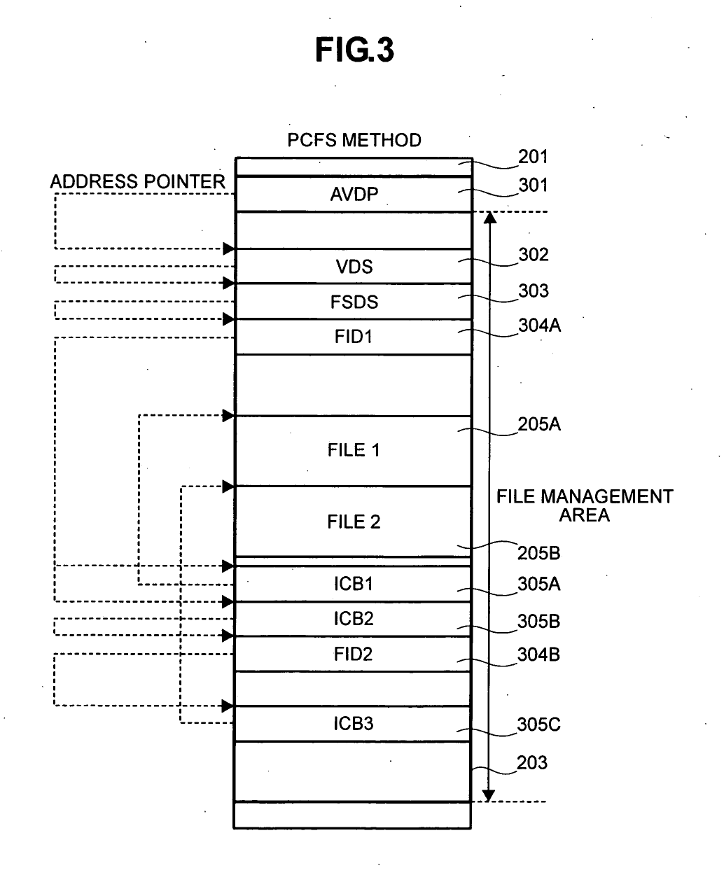

FIG. 3 shows the file and file allocation of a recording medium to which PCFS is applied as the file system. An exemplary structure of UDF is used. In FIG. 3, 201 denotes a recording medium, 301 denotes AVDP (Anchor Volume Descriptor), 302 denotes VDS (Volume Descriptor Sequence), 303 denotes FSDS (File Set Descriptor Sequence), 304 denotes FID (File Identifier Descriptor), 305 denotes ICB (Information Control Block), and 205 denotes the file.

Basically, the content of the volume is described in VDS 302 specified by AVDS 301 positioned at a fixed address, and the number of files and recording date and time in the whole recording medium are described in FSDS 303 indicated by VDS 302. FSDS 303 accesses file 205 through ICB 305 on which the data length, location, and attribute of the file are described by FID 304, which indicates a part of the file name or attribute. ICB 305 of the directory indicates the attribute of the directory, accessible file, and FID 304 of the directory.

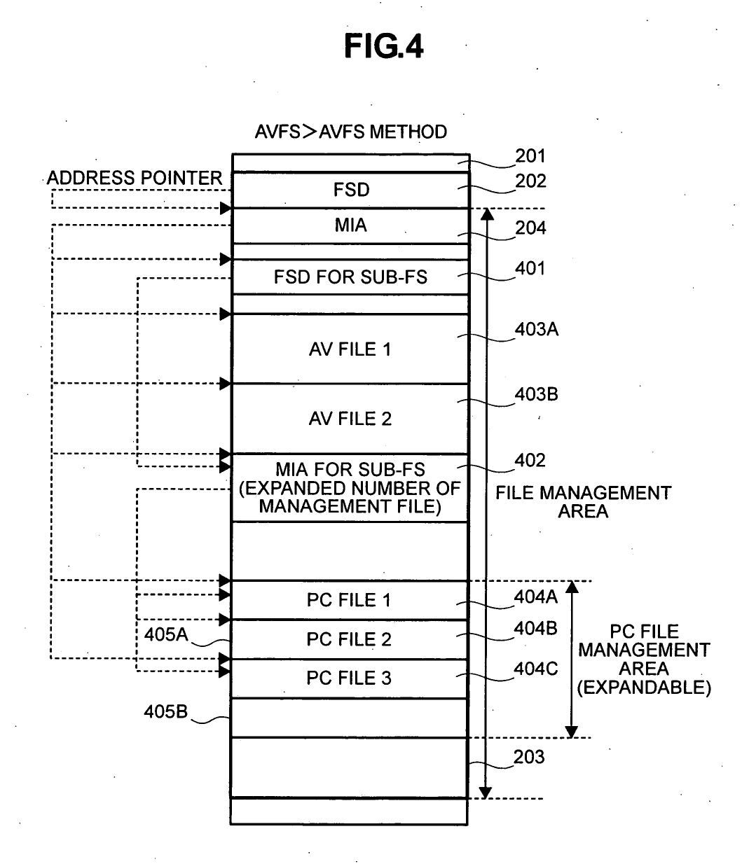

FIG. 4 shows the file and file allocation of a recording medium to which AVFS>AVFS is applied as the file system. In FIG. 4, 202 denotes FDS of AVFS as the main file system, 203 denotes the recording area on which the file and file management information managed by the main file system are recorded, 204 denotes MIA of AVFS that is the main file system, 401 denotes the expanded AVFS that is the sub-file system, 402 denotes MIA of the expanded AVFS that is the sub-file system, 403 denotes the AV file that is managed directly by the main file system, 405 denotes the block assigned as the management area of the sub-file system, and 404 denotes the PC file managed by the sub-file system.

The file system AVFS>AVFS shown in FIG. 4, FSD 401 for the sub-file system and MIA 402 for the sub-file system are handled as a special file in the main file system. In this case, a special file means the file is defined as a PC management file managed by giving specified attributes and a file name different from the AV file. Usually, the AV file has a prescribed directory structure for recording/regeneration compatibility with diverse AV recorders. Accordingly, the file for FSD 401 and MIA 402 of the sub-file system is managed under a directory structure that is prescribed differently from this directory structure so that an AV recorder can recognize the existence of the AV file, but cannot directly access the AV file.

PC file 404 managed by the sub-file system is recorded only in management area 405 of the sub-file system. PC file 404 is handled as a normal file in the sub-file system, and sub-file system management area 405 is handled in the main file system as one file like FSD 401 and MIA 402 of the sub-file system. As a result, the file is rendered inaccessible directly from an AV recorder.

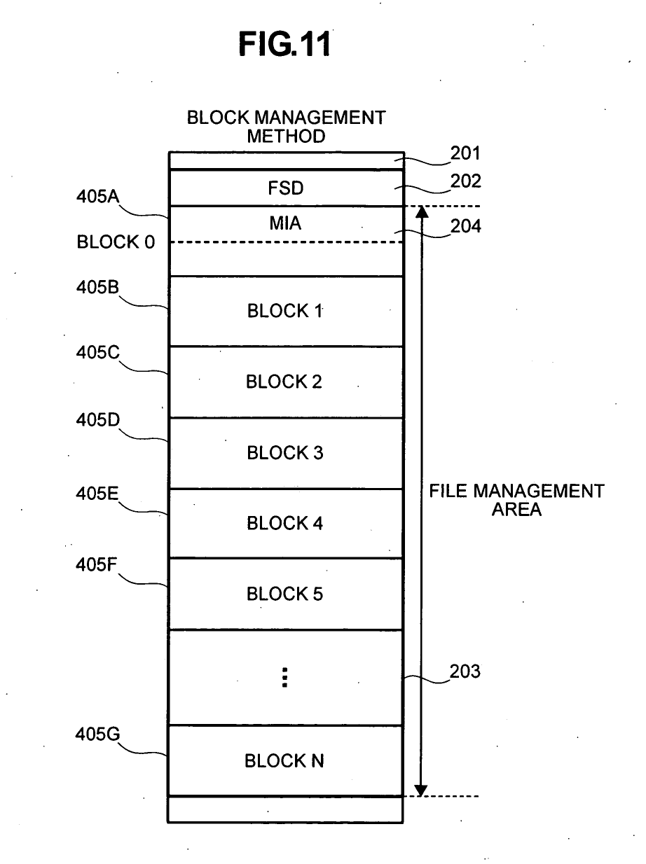

FIG. 11 shows a diagram of recording area 203, on which the file and file management information managed by the main file system is to be recorded, divided in minimum file size units to be managed by the main file system. In this diagram, each block has the minimum block size unit that can be managed by the main file system, and several 10 MB units are usually assigned as the block size in the system for handling the AV file.

Therefore, the block size of management area 405 of the sub-file system is expanded as required, and the file management information in the main file system is changed concomitantly with the size change of management area 405 of the sub-file system.

If the PC file is increased/decreased in management area 405 of the sub-file system, and the sub-file system management area 405 is not changed, only the system management information of the sub-file system is changed and the system management information of the main file system is not changed.

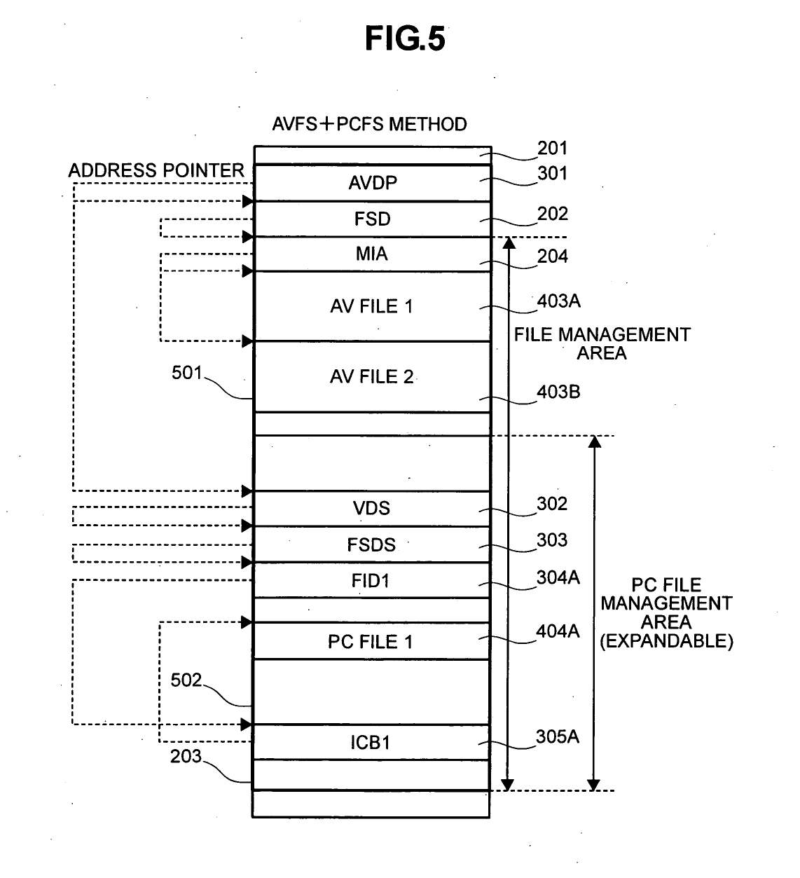

FIG. 5 shows the file and file allocation of a recording medium to which AVFS+PCFS is applied as the file system. In FIG. 5, 203 denotes the recording area on which the file and file management information are recorded; 501 denotes the recording area on which the AVFS file and file management information are recorded; and 502 denotes the recording area on which PCFS file and file management information are recorded. The file management method of both file systems, namely AVFS and PCFS, is basically the same as that of AVFS shown in FIG. 2 and PCFS shown in FIG. 3.

Several methods of mutual area management in the file system are available. Any way, a means for area management that is common for both file systems is needed when the proportion of the recording areas 501 to 502 on which the file and file management information managed by AVFS and PCFS are respectively recorded is changed as required for using the recording medium. However, each recording area assigned to AVFS or PCFS is managed by a corresponding file system. As a result, it is possible to access recording area 203 on which the file and file management information assigned to the whole recording medium from both areas where the management information is recorded.

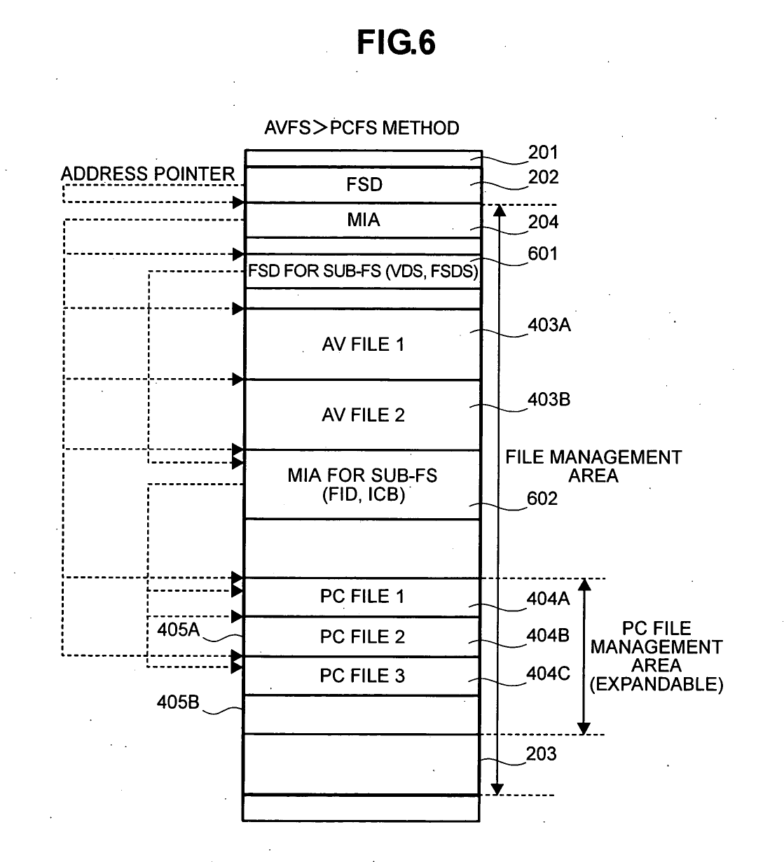

FIG. 6 shows the file and file allocation of the recording medium to which AVFS>PCFS is applied as the file system. In FIG. 6, 202 denotes FDS of AVFS as the main file system; 203 denotes a recording area on which the file and file management information managed by the main file system; 204 denotes MIA of AVFS as the main file system; 601 denotes FSD of PCFS as the sub-file system; 602 denotes MIA of PCFS as the sub-file system; 403 denotes the AV file managed directly by the main file system; 405 denotes a block assigned as the management area of the sub-file system; and 404 denotes the PC file managed by the sub-file system.

In FIG. 6, the FDS 601 of the sub-file system is based on the supposition that the style of the VDP 302 and FSDS 303 of conventional PCFS is converted to the style suitable for the sub-file system and the FDS 601 is allocated on the FDS 601 area, and the MIA 602 of the sub-file system is based on the supposition that the FID 304 and ICB 305 of the conventional PCFS are recorded together in the MIA area that is provided exclusively for FID 304 and ICB 305 in the same manner as the table management method. However, the style is by no means limited to the above, and as a matter of course FID 304 and ICB 305 can be allocated in the management area of the sub-file system in the same manner as used conventionally without any problem.

The relation between the sub-file system and main file system in the file system shown in FIG. 6, namely AVFS>PCFS, is approximately the same as the relation between the two file systems in AVFS>AVFS shown in FIG. 4. FSD 601 for the sub-file system and MIA602 for the sub-file system are handled as a special file in the main file system, and managed under a directory structure designed differently from the directory structure provided for AV. FSD 601 and MIA 602 are the files that are recognized by an AV recorder but they cannot be directly accessed.

Furthermore, PC file 404 to be managed by the sub-file system is recorded only in management area 405 of the sub-file system, and block 405 assigned as the sub-file system management area is handled as one file in the main file system in the same manner used for FSD 401 and MIA 402 of the sub-file system. Block 405 is the file that cannot be accessed directly from an AV recorder.

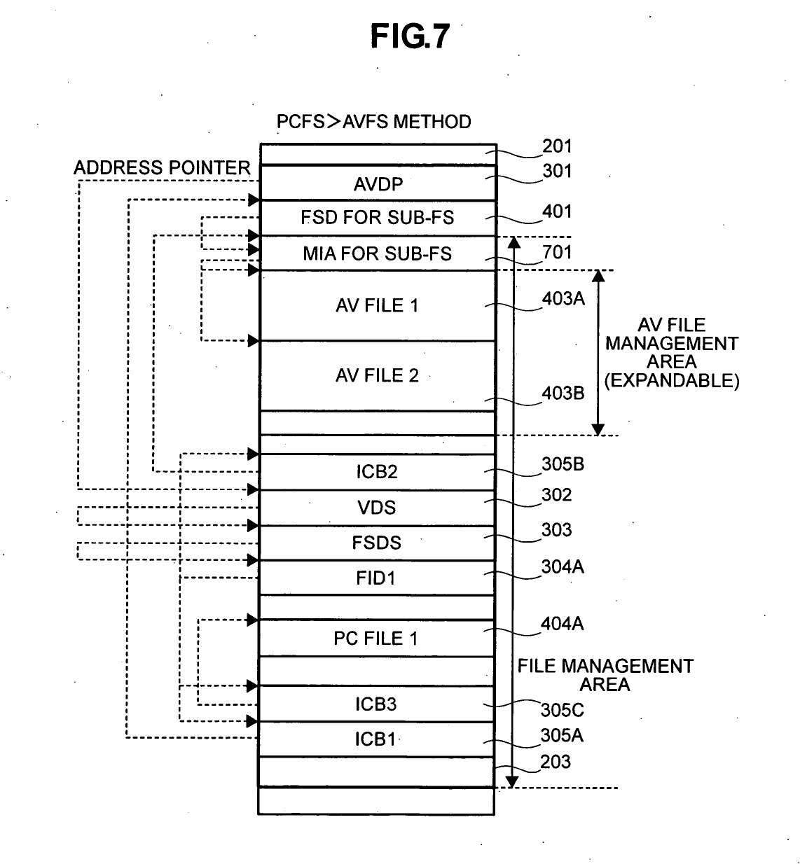

FIG. 7 shows the file and file allocation of a recording medium to which PCFS>AVFS is applied as the file system. In FIG. 7, 201 denotes a recording medium; 301 denotes AVDP of PCFS that is the main file; 302 denotes VDS; 303 denotes FSDS; 304 denotes FID; 305 denotes ICB; 404 denotes a PC file managed by the main file system; 401 denotes FSD for sub-file system AVFS; 701 denotes MIA for sub-file system; and 403 denotes an AV file managed by the sub-file system.

The relation between the sub-file system and the main file system in the file system PCFS>AVFS shown in FIG. 7 is approximately the same as the relation between the two file systems in AVFS>AVFS shown in FIG. 4, and FSD 401 for the sub-file system and MIA 402 for the sub-file system are handled as a file having a special attribute on the main file system. Furthermore, it is possible to allocate FSD of the sub-file system on the fixed address so that an AV recorder can recognize the existence of FSD. In this case, it is probable that PCFS, namely the main file system, cannot operate the file of FSD 401 of the sub-file system at all depending on the address, but the inoperability does not cause any problem. However, as much additional recording area as possible needs to be allocated to PCFS and AVFS to record the data directly on the AVFS sub-file system used by an AV recorder. Hence, for using a PC, it is effective to minimize the management area of AVFS, and to employ PCFS for area management so that AVFS manages as large an area as possible when a recording medium is taken from the PC.

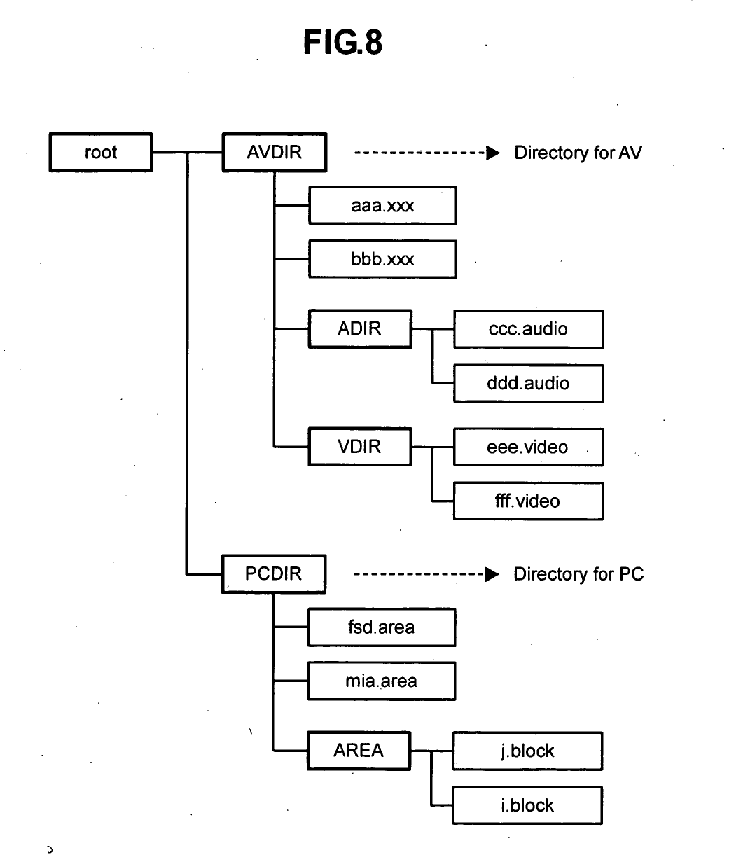

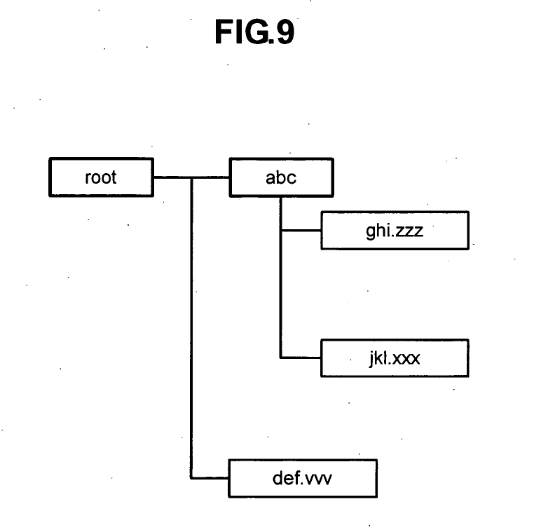

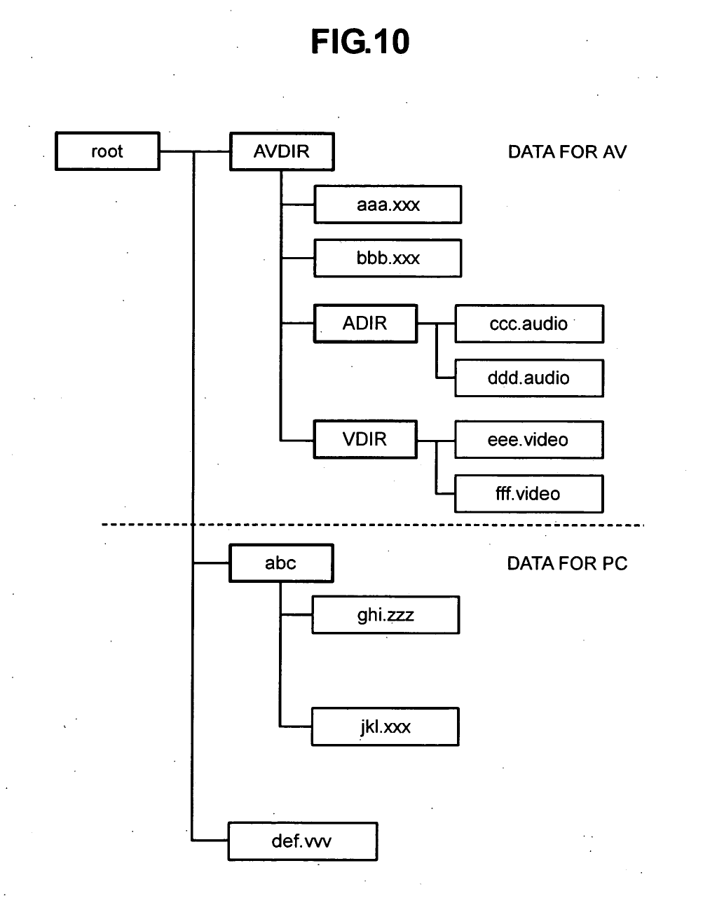

Finally, a user interface, formed by integrating two file systems on a PC and provided by combining two file systems that are for PC (AVFS expanded and PCFS) and for AV (AVFS), respectively, is now described with reference to FIGS. 8 to 10. Herein, AVFS>AVFS is used exemplarily. FIG. 8 shows the directory structure of the main file. In FIG. 8, the directory “AVDIR” is the exclusive directory for storing the file for AV, and the directory “PCDIR” is the exclusive directory for storing the file non-AV files. The sub-file system management method described in the subject of AVFS>AVFS shown in FIG. 4 is used herein. FSD 401 for the sub-file system, MIA 402 for the sub-file system, and the file that indicates block 405 allocated as the management area of the sub-file system exists under “PCDIR” in a previously set format. FIG. 9 shows the directory structure of the sub-file system that manages the PC file. The PC file has an discretionary format. FIG. 10 shows the directory structure in which the files managed by two file systems that are different in type are integrated. In the AV file system, the file is allocated under the generally determined directory name. According to the above, it is possible to construct the integrated interface by switching the directory that cannot be directly on the PC by a user from its location among the determined directories to the path of the file system for a PC.

According to the embodiments of the present invention, it is possible to provide a new file system capable of managing more files while maintaining conventional compatibility with the AV file system is maintained by combining PCFS (file system for PC) to the main AVFS (file system for AV) or by employing AVFS and PCFS together. As a result, the present invention realizes an environment wherein one disc can be used by means of an AV apparatus and also by a PC.

According to the present invention, it is possible to provide a new file system that is capable of managing more files while compatibility with a conventional one-file system is maintained by combining two-file systems or by employing two file systems together. As a result, the present invention realizes an environment wherein one disc can be used in a plurality of environments.

1. A recording medium on which a file for storing write data and file management information for managing the file are recorded, wherein;
first file management information for managing a first file and second file management information for managing a second file that is different from the first file management information are recorded as the file management information, the number of files manageable by the second file management information is larger than the number of files manageable by the first file management information, and only one of the first file management information and the second file management information includes the management information for managing the recording area of the first file and the recording area of the second file.

2. The recording medium as claimed in claim 1 wherein the first file is an AV file and the second file is a PC file.

3. The recording medium as claimed in claim 1 wherein the first file management information comprises a plurality of different tables.

4. The recording medium as claimed in claim 1 wherein the second file management information is structured without table.

5. The recording medium as claimed in claim 1 wherein the first file management information and the second file management information comprise a plurality of different tables respectively.

6. The recording medium as claimed in claim 1 wherein the first file management information includes the management information for managing the second file management information.

7. The recording medium as claimed in claim 1 wherein the first file management information includes the attribute information for indicating the file attribute.

8. The recording medium as claimed in claim 7 wherein the attribute information is the file name.

9. The recording medium as claimed in claim 1 wherein the second file management information includes the management information for managing the first file management information.

10. The recording medium as claimed in claim 1, wherein the second file management information includes the attribute information for indicating the file attribute.

11. The recording medium as claimed in claim 10, wherein the attribute information is the file name.

12. A recording apparatus for recording depending on the type of data to be written on the first file or the second file of the recording medium as claimed in claim 1.

13. A regenerating apparatus that reads the data from the first file or the second file of the recording medium as claimed in claim 1 and regenerates the data.

14. A recording medium having the directory relating to the first file recording area and the directory relating to the second file recording area, wherein the first file management information as described in claim 1 is formed in the directory structure.

15. A recording medium having the directory relating to the first file recording area and the directory relating to the second file recording area, wherein the second file management information as described in claim 1 is formed in the directory structure.

16. A regenerating apparatus for regenerating the recording medium as claimed in claim 14, wherein the directory that relates to the first file recording area is displayed and the directory that relates to the second file recording area is not displayed when the directory of the first file management information is displayed on a monitor.

17. A regenerating apparatus for regenerating the recording medium as claimed in claim 15, wherein the directory that relates to the second file recording area is displayed and the directory that relates to the first file recording area is not displayed when the directory of the second file management information is displayed on a monitor.
